(19) United States
(12) Patent Application Publication
(10) Pub. No.: US 2025/0062066 A1
(43) Pub. Date: Feb. 20, 2025

(54) COIL DEVICE AND TRANSFORMER DEVICE

(71) Applicant: MINEBEA MITSUMI Inc., Kitasaku-gun (JP)

(72) Inventors: Masahiro TANAKA, Kitasaku-gun (JP); Mitsuo MATSUSHIMA, Kitasaku-gun (JP)

(21) Appl. No.: 18/780,951

(22) Filed: Jul. 23, 2024

(30) Foreign Application Priority Data
Aug. 18, 2023 (JP) 2023-133297

(51) Int. Cl. H01F 27/29; H01F 27/06; H01F 27/24; H01F 27/32

(52) U.S. Cl. CPC H01F 27/292; H01F 27/06; H01F 27/24; H01F 27/325; H01F 2027/065

(57) ABSTRACT

A coil device of the present application includes a bobbin including a winding core portion, a coil wound around the winding core portion, a flange portion provided integrally with the winding core portion, a pin terminal block provided integrally with the flange portion, a plurality of pin terminals (P) provided at predetermined intervals at the pin terminal block and connected to lead wires of the coil, and a circuit board connected to the plurality of pin terminals (P). The pin terminal block includes a plurality of pin terminal groove portions formed in a groove shape along an axial direction of the winding core portion, and a pin fixing portion formed in an interior space of the pin terminal groove and integrally fixed to one end of the pin terminal (P).

### CROSS-REFERENCE TO RELATED APPLICATIONS

This application claims the benefit of priority to Japanese Patent Application Number 2023-133297 filed on Aug. 18, 2023. The entire contents of the above-identified application are hereby incorporated by reference.

### TECHNICAL FIELD

The present invention relates to a coil device and a transformer device.

### BACKGROUND ART

In the related art, a bobbin for a coil transformer used as a transformer of an electronic device or the like has been proposed, and includes a winding core, an upper flange, a lower flange, and a pin terminal (for example, see Patent Document 1). The bobbin for a coil transformer is provided with a pin terminal embedding portion where the pin terminal is embedded at a side surface of the lower flange, and a lead wire drawing groove is formed at a tip surface of the pin terminal embedding portion.

In this bobbin for a coil transformer, after a copper wire of a winding portion of an inductor is wound around a winding core, a lead wire drawn out from the winding is passed through the lead wire drawing groove between the pin terminal embedding portions and tied to the pin terminal.

### CITATION LIST

### Patent Literature

Patent Document 1: JP 7-320953 A

### SUMMARY OF INVENTION

### Technical Problem

However, in the bobbin for a coil transformer disclosed in Patent Document 1, due to the distance between the pin terminals, the wire diameter of the lead wires, and the like, the distance between the lead wires may be reduced, causing a short circuit.

In order to avoid the short circuit between the lead wires, it is conceivable to use another pin terminal different from the pin terminal to be originally connected, thereby securing a distance between the pin terminals and avoiding the short circuit between the lead wires.

However, in this case, since the number of pin terminals provided in the pin terminal embedding portion is limited, the necessary number of pin terminals is insufficient, and in order to secure the necessary number of pin terminals, the size of the pin terminal embedding portion needs to be increased. Thus, there is a possibility of increasing the size of the bobbin itself.

An example of a solution to the problem is to provide a coil device and a transformer device of the present invention enabling a reduced size of an entirety thereof while ensuring insulation distance between lead wires.

### Solution to Problem

A coil device of the present invention includes: a bobbin including a winding core portion; a coil wound around the winding core portion; a flange portion provided integrally with the winding core portion; a pin terminal block provided integrally with the flange portion; a plurality of pin terminals provided at the pin terminal block at predetermined intervals and connected to a lead wire of the coil; and a circuit board connected to the plurality of pin terminals, wherein the pin terminal block includes: a plurality of pin terminal groove portions formed in a groove shape along an axial direction of the winding core portion; and a pin fixing portion formed in an interior space of the pin terminal groove portion and integrally fixed to one end portion of the pin terminal.

### BRIEF DESCRIPTION OF DRAWINGS

FIG. 1 is a perspective view illustrating an overall configuration of a coil device according to an embodiment being one example of the present invention.

FIG. 2 is an exploded perspective view illustrating a configuration of the coil device according to the embodiment being one example of the present invention.

FIG. 3 is a perspective view illustrating a bobbin for the coil device according to the embodiment being one example of the present invention viewed obliquely from above.

FIG. 4 is a perspective view illustrating a configuration illustrating the bobbin for the coil device according to the embodiment being one example of the present invention viewed from the side.

FIG. 5 is a perspective view illustrating the bobbin for the coil device according to the embodiment being one example of the present invention viewed from below.

FIG. 6 is a partially enlarged perspective view illustrating a configuration of a pin terminal block of the bobbin for the coil device according to the embodiment being one example of the present invention viewed from above.

FIG. 7 is a partially enlarged perspective view illustrating a configuration of the pin terminal block of the bobbin for the coil device according to the embodiment being one example of the present invention viewed from below.

FIG. 8 is a side view for explaining a difference in configuration between a pin terminal block (A) of the coil device according to the embodiment being one example of the present invention and a pin terminal block (B) of a coil device having a conventional configuration.

FIG. 9 is a side view for explaining a case where a height of a coil device (A) according to the embodiment being one example of the present invention is compared with a height of a coil device (B) having a conventional configuration.

FIG. 10 is a perspective view illustrating a connection state (A) of a lead wire of the coil device according to the embodiment being one example of the present invention to a pin terminal and a connection state (B) of a lead wire of a coil device having a conventional configuration to a pin terminal.

### DESCRIPTION OF EMBODIMENTS

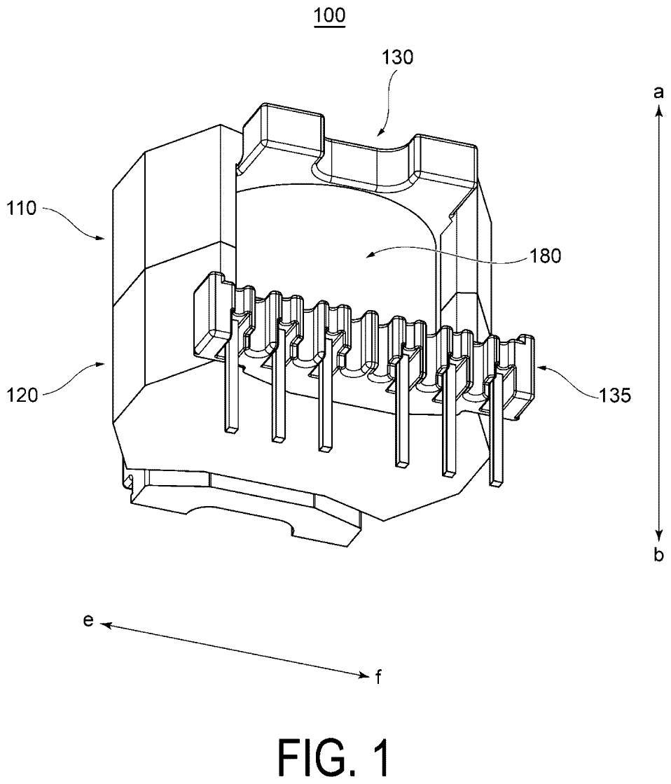

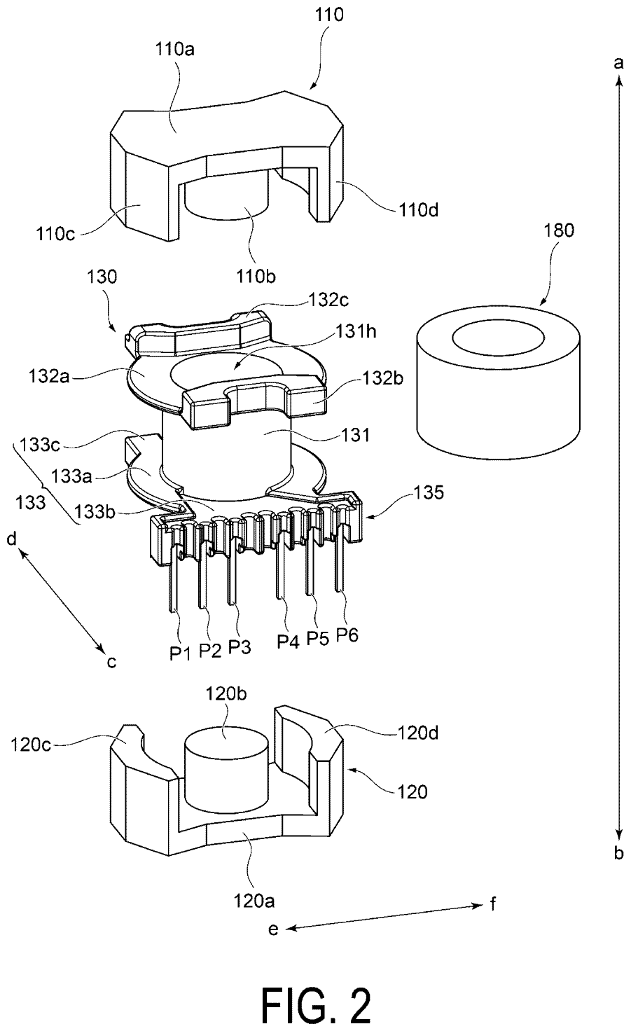

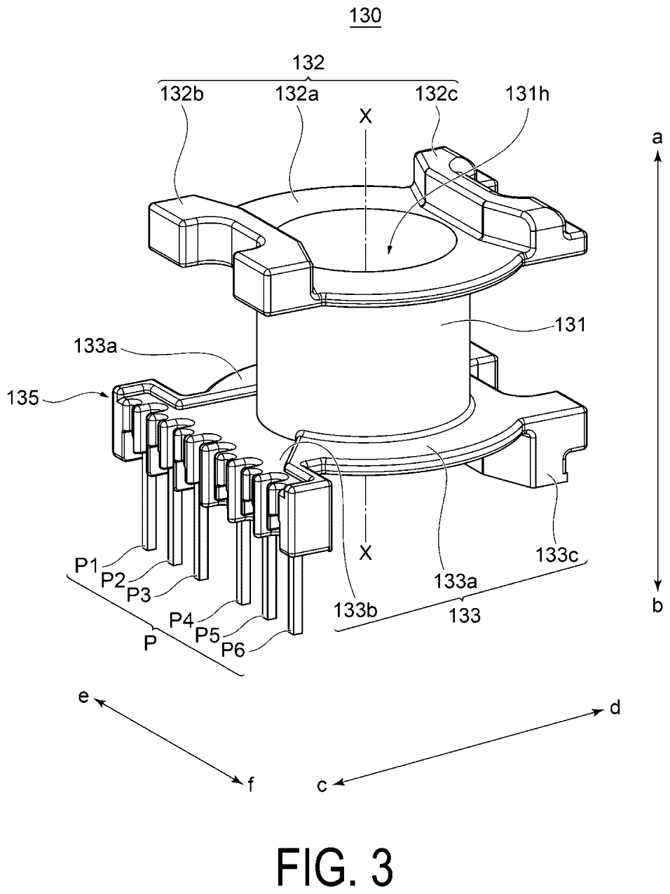

An embodiment being one example of the present invention will be described below with reference to the drawings. FIG. 1 is a perspective view illustrating an overall configuration of a coil device according to an embodiment being one example of the present invention. FIG. 2 is an exploded perspective view illustrating a configuration of the coil device according to the embodiment being one example of the present invention. FIG. 3 is a perspective view illustrating a bobbin for the coil device according to the embodiment being one example of the present invention viewed obliquely from above.

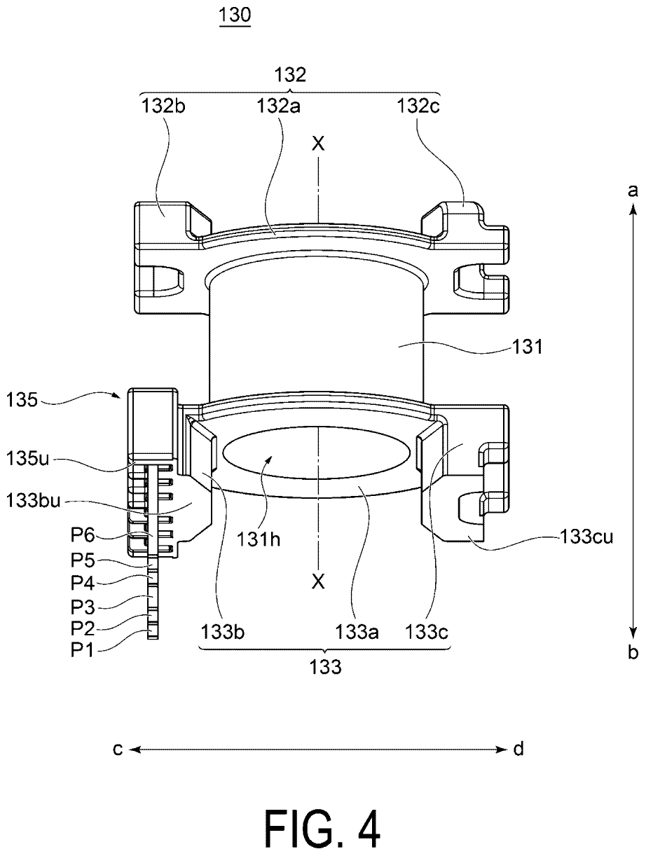

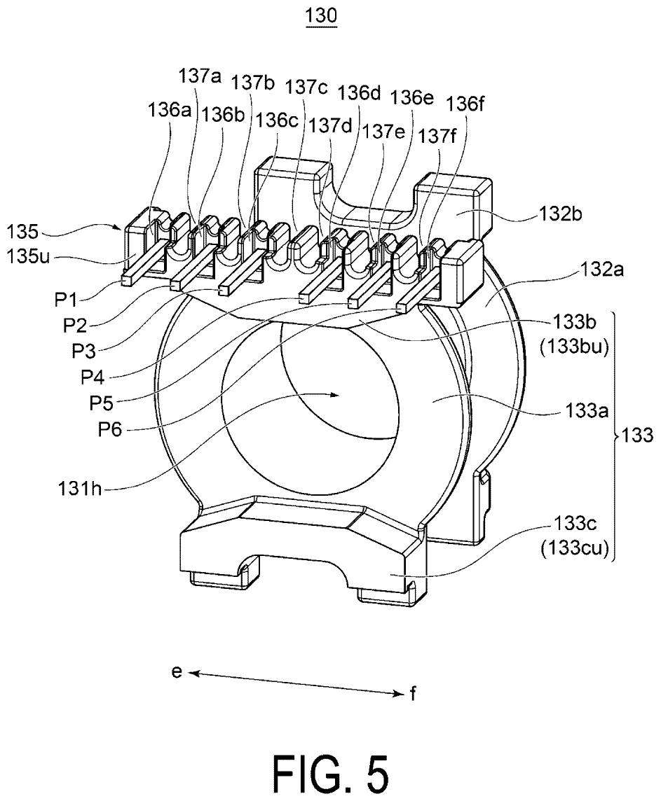

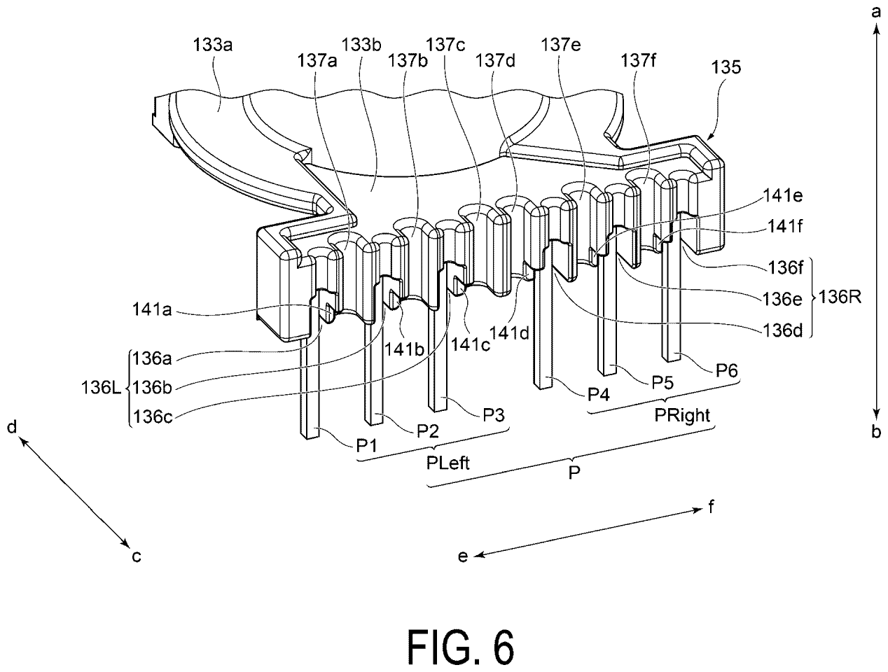

FIG. 4 is a perspective view illustrating a configuration illustrating the bobbin for the coil device according to the embodiment being one example of the present invention viewed from the side. FIG. 5 is a perspective view illustrating the bobbin for the coil device according to the embodiment being one example of the present invention viewed from below. FIG. 6 is a partially enlarged perspective view illustrating a configuration of a pin terminal block of the bobbin for the coil device according to the embodiment being one example of the present invention viewed from above.

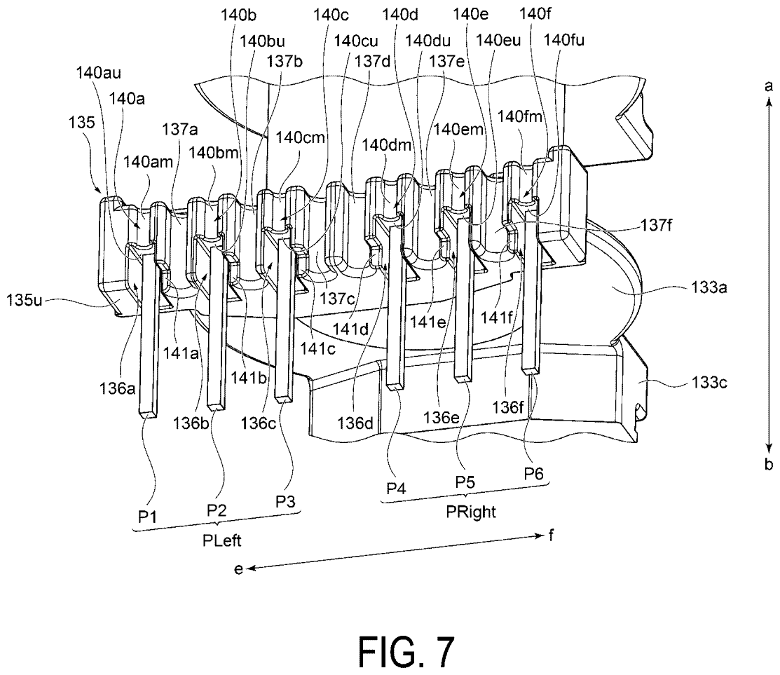

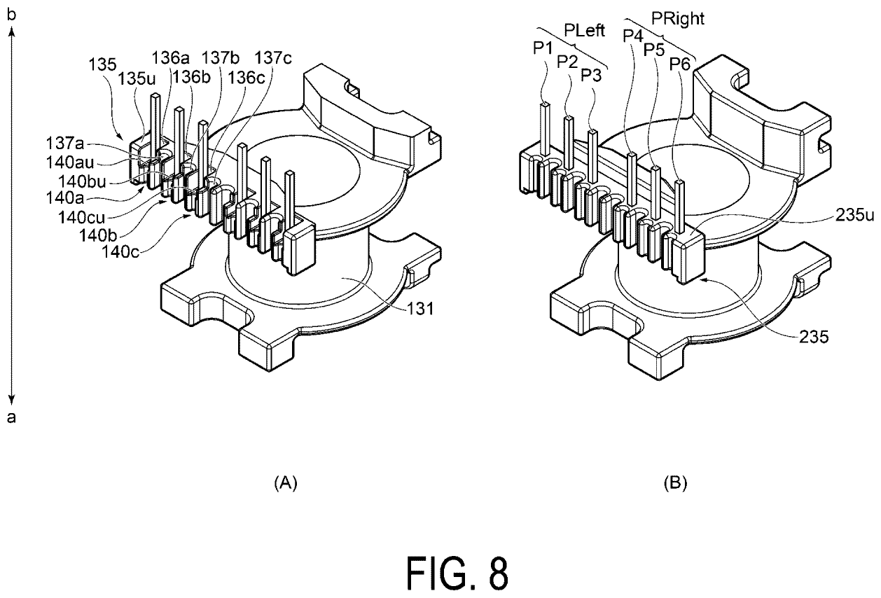

FIG. 7 is a partially enlarged perspective view illustrating a configuration of the pin terminal block of the bobbin for the coil device according to the embodiment being one example of the present invention viewed from below. FIG. 8 is a side view for explaining a difference in configuration between a pin terminal block (A) of the coil device according to the embodiment being one example of the present invention and a pin terminal block (B) of a coil device having a conventional configuration.

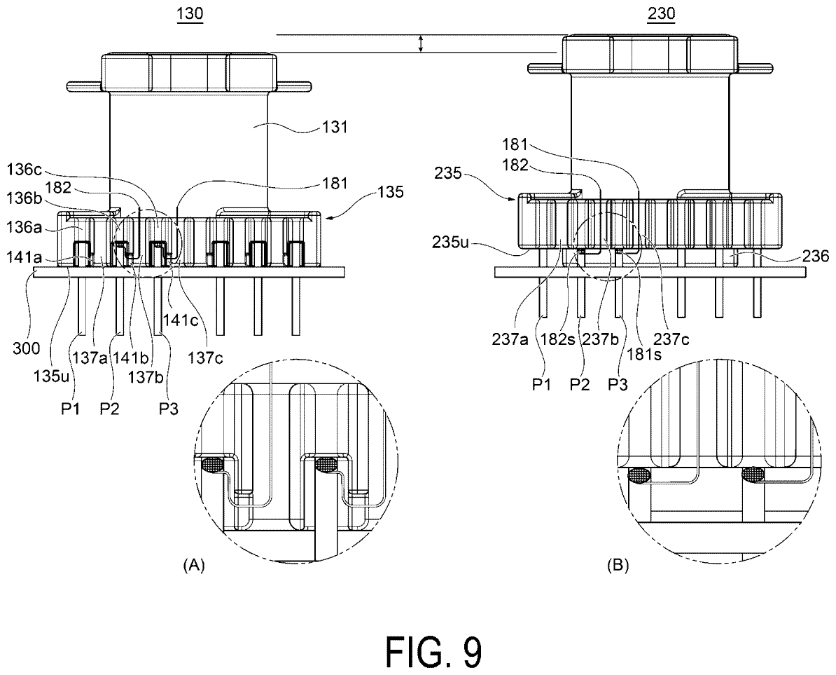

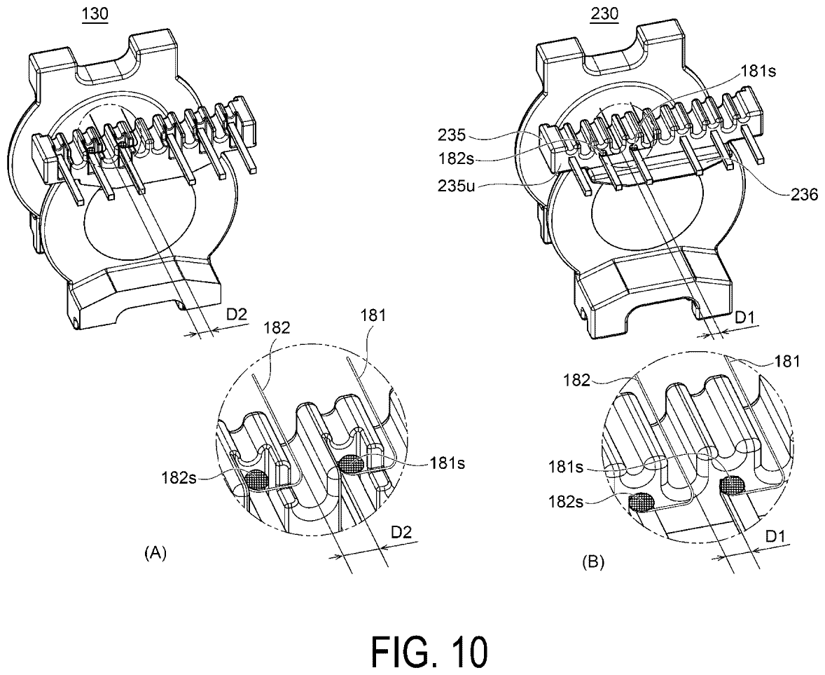

FIG. 9 is a side view for explaining a case where a height of a coil device (A) according to the embodiment being one example of the present invention is compared with a height of a coil device (B) having a conventional configuration. FIG. 10 is a perspective view illustrating a connection state (A) of a lead wire of the coil device according to the embodiment being one example of the present invention to a pin terminal and a connection state (B) of a lead wire of a coil device having a conventional configuration to a pin terminal.

Note that, in the description of embodiments of the present invention, for convenience of description, an arrow ab direction is referred to as a vertical direction, an arrow a direction is defined to be an upper side or upward, and an arrow b direction is defined to be a lower side or downward. An arrow cd direction is referred to as a depth direction or a front-rear direction, an arrow c direction is referred to as a front side or a frontward, and an arrow d direction is referred to as a back side or rearward. An arrow ef direction is referred to as a left-right direction or a horizontal direction, an arrow e direction is referred to as a left side or leftward, and an arrow f direction is referred to as a right side or rightward. However, the vertical direction (arrow ab direction), the depth direction (arrow cd direction), and the horizontal direction (arrow ef direction) are merely used for convenience of description, and are irrelevant to the directions in the case of actual use.

### Coil Device

As illustrated in FIGS. 1 and 2, a coil device 100 used in an electronic device or the like mainly includes a core 110 (hereinafter referred to as “upper core”) at the upper side (arrow a direction), a core 120 (hereinafter referred to as “lower core”) at the lower side (arrow b direction), a bobbin 130, a coil 180, and the like.

As illustrated in FIG. 2, the upper core 110 is a core portion attached above (arrow a direction) a middle position of the bobbin 130 in the vertical direction (arrow ab direction), and has a substantially E shape in a side view.

The upper core 110 includes a top plate portion 110a formed of a plate-shaped member having a substantially rectangular shape in a plan view, a columnar middle leg portion 110b protruding downward (arrow b direction) from the center of the top plate portion 110a, and side leg portions 110c and 110d protruding downward (arrow b direction) from both end portions of the top plate portion 110a so as to face each other with the middle leg portion 110b interposed between the side leg portions 110c and 110d.

The middle leg portion 110b of the upper core 110 is a portion inserted into a through hole 131h (FIGS. 2 and 3) of a winding core portion 131 of the bobbin 130 to be described later, from the upper side (arrow a direction). The side leg portions 110c and 110d of the upper core 110 are portions disposed so as to surround an upper flange body 132a from the outer circumferential side in the radial direction while avoiding an upper protruding portion 132b and an upper protruding portion 132c of the bobbin 130 when the middle leg portion 110b is inserted into the through hole 131h of the winding core portion 131.

The lower core 120 is a core portion attached below (arrow b direction) a middle position of the bobbin 130 in the vertical direction (arrow ab direction), and has a substantially E shape in a side view.

The lower core 120 includes a bottom plate portion 120a formed of a plate-shaped member having a substantially rectangular shape in a plan view, a columnar middle leg portion 120b protruding upward (arrow a direction) from the center of the bottom plate portion 120a, and side leg portions 120c and 120d protruding upward (arrow a direction) from both end portions of the bottom plate portion 120a so as to face each other with the middle leg portion 120b interposed between the side leg portions 120c and 120d.

The middle leg portion 120b of the lower core 120 is a portion inserted into the through hole 131h (FIGS. 2 and 3) of the winding core portion 131 of the bobbin 130 to be described later, from the lower side (arrow b direction). The side leg portions 120c and 120d of the lower core 120 are portions disposed so as to surround a lower flange body 133a from the outer circumferential side in the radial direction while avoiding a lower protruding portion 133b and a lower protruding portion 133c of the bobbin 130 when the middle leg portion 120b is inserted into the through hole 131h of the winding core portion 131. In this case, the lower core 120 has the same shape and the same size as the upper core 110.

As illustrated in FIGS. 3 and 4, the bobbin 130 is a molded product made of an insulating resin, and includes the substantially cylindrical winding core portion 131, an upper flange portion 132, a lower flange portion 133, and a pin terminal block 135 provided integrally with the lower flange portion 133.

The winding core portion 131 has a cylindrical shape provided with the through hole 131h, the upper flange portion 132 is integrally formed at an end portion at the upper side (hereinafter referred to as “upper end portion”) of the winding core portion 131, and the lower flange portion 133 is integrally formed at an end portion at the lower side (hereinafter referred to as “lower end portion”) of the winding core portion 131. Note that the winding core portion 131 is not limited to a cylindrical shape, and may be a rectangular tube shape or the like.

The upper flange portion 132 includes an upper flange body 132a being a flange-shaped flange protruding in a disk shape from the upper end portion of the winding core portion 131 in the outer circumferential direction, an upper protruding portion 132b having a substantial C-shape in a plan view and integrally provided at the front side (arrow c direction) and the back side (arrow d direction) in the depth direction (arrow cd direction) of the upper flange body 132a, and an upper protruding portion 132c.

The upper flange body 132a of the upper flange portion 132 is a portion defining the radial thickness of the coil 180 where copper wires of the coil 180 are wound around the winding core portion 131. The upper protruding portion 132b of the upper flange portion 132 and the upper protruding portion 132c are portions fixing the position of the upper core 110 and serving as lead-out grooves for copper wires.

The lower flange portion 133 includes the lower flange body 133a being a flange-shaped flange protruding in a disk shape from the lower end portion of the winding core portion 131 in the outer circumferential direction, the lower protruding portion 133b having a substantial C-shape in a plan view and integrally provided at the front side (arrow c direction) and the back side (arrow d direction) in the depth direction (arrow cd direction) of the lower flange body 133a, and the lower protruding portion 133c.

The lower flange body 133a of the lower flange portion 133 has the same outer diameter as the upper flange body 132a of the upper flange portion 132, and is a portion defining the radial thickness of the coil 180 where the copper wires of the coil 180 are wound around the winding core portion 131. The lower protruding portion 133b of the lower flange portion 133 and the lower protruding portion 133c are portions fixing the position of the lower core 120 and serving as lead-out grooves for the copper wires.

As illustrated in FIG. 4, the lower protruding portion 133b and the lower protruding portion 133c of the lower flange portion 133 have the same height in the vertical direction (arrow ab direction), where a circuit board 300 (FIG. 9(A)) is brought into contact with and fixed to respective bottom surface 133bu and a bottom surface 133cu.

The pin terminal block 135 is integrally formed at the lower protruding portion 133b of the lower flange portion 133 so as to protrude toward the front side (arrow c direction). The pin terminal block 135 has a rectangular parallelepiped shape being horizontally long (arrow ef direction) and has the same height as the lower protruding portion 133b and lower protruding portion 133c.

That is, when the circuit board 300 is fixed to the bottom surface 133bu of the lower protruding portion 133b and the bottom surface 133cu of the lower protruding portion 133c, the circuit board 300 is also fixed to a bottom surface 135u of the pin terminal block 135 in a state of being in contact with the bottom surface 135u.

As illustrated in FIGS. 5 and 6, the pin terminal block 135 has a plurality of (in this case, six) groove portions (hereinafter referred to as “pin terminal groove portions”) 136a to 136f corresponding to a plurality of (in this case, six) pin terminals P (P1 to P6) disposed at given intervals respectively in the horizontal direction (arrow ef direction) orthogonal to the depth direction (arrow cd direction). Note that the number of pin terminals P (P1 to P6) is equal to the number of pin terminal groove portions 136, and corresponds to the number of lead wires drawn out from the coil 180.

In this case, the pin terminals P1 and P3 at the left side (arrow e direction) of the pin terminal block 135 may be referred to as a left-side pin terminal group PLeft, and the pin terminals P4 and P6 at the right side (arrow f direction) of the pin terminal block 135 may be referred to as a right-side pin terminal group PRight.

Similarly, the pin terminal groove portions 136a to 136c at the left side of the pin terminal block 135 (arrow e direction) may be referred to as a left-side pin terminal groove portion 136L, and the pin terminal groove portions 136d to 136f at the right side of the pin terminal block 135 (arrow f direction) may be referred to as a right-side pin terminal groove portion 136R.

The plurality of pin terminal groove portions 136a to 136f are formed to have a U-shaped cross section being vertically long in the vertical direction (arrow ab direction) along the axis X direction of the winding core portion 131 of the bobbin 130.

The plurality of pin terminal groove portions 136a to 136f are formed horizontally (arrow ef direction) at given intervals, and between the pin terminal groove portions 136a to 136f, a plurality of groove portions 137a to 137f (hereinafter referred to as “lead-wire drawing groove portions”) are formed in a groove shape along the axis X direction.

That is, the plurality of pin terminal groove portions 136a to 136f and the plurality of lead-wire drawing grooves 137a to 137f are alternately disposed. However, in this case, since the pin terminal groove portion 136a of the left-side pin terminal groove portion 136L is disposed at the leftmost side of the pin terminal block 135 (arrow e direction) and the pin terminal groove portion 136f of the right-side pin terminal groove portion 136R is disposed at the rightmost side of the pin terminal block 135 (arrow f direction), the pin terminal groove portion 136c and the pin terminal groove portion 136d are disposed adjacent to each other in the central portion of the pin terminal block 135.

Note that in the left-side pin terminal groove portion 136L, the pin terminal groove portion 136a and the lead-wire drawing groove portion 137a form a pair, the pin terminal groove portion 136b and the lead-wire drawing groove portion 137b form a pair, and the pin terminal groove portion 136c and the lead-wire drawing groove portion 137c form a pair.

Similarly, in the right-side pin terminal groove portion 136R, the pin terminal groove portion 136d and the lead-wire drawing groove portion 137d form a pair, the pin terminal groove portion 136e and the lead-wire drawing groove portion 137e form a pair, and the pin terminal groove portion 136f and the lead-wire drawing groove portion 137f form a pair. As illustrated in FIG. 5, the plurality of pin terminal groove portions 136a to 136f are formed deeper than the plurality of lead-wire drawing groove portions 137a to 137f in the depth direction (arrow cd direction).

Specifically, as illustrated in FIG. 7, the plurality of lead-wire drawing groove portions 137a to 137f are formed to have a depth of about half in the depth direction (arrow cd direction) of the pin terminal block 135, whereas the plurality of pin terminal groove portions 136a to 136f are formed to have a depth of about half or more in the depth direction (arrow cd direction) of the pin terminal block 135.

Here, since the pin terminal groove portions 136a to 136c of the left-side pin terminal groove portion 136L have the same shape, the pin terminal groove portion 136a will be described below as a representative. As illustrated in FIG. 7, the pin terminal groove portion 136a has a pin fixing portion 140a having a substantially rectangular parallelepiped shape integrally provided so as to occupy an upper half of a groove space of the pin terminal groove portion 136a in the vertical direction (arrow ab direction).

Since the pin fixing portion 140a occupies almost half of the upper side (arrow a direction) of the groove space of the pin terminal groove portion 136a in the vertical direction (arrow ab direction), an bottom surface 140au of the pin fixing portion 140a is located at the upper side (arrow a direction) of the bottom surface 135u of the pin terminal block 135.

One end portion of the pin terminal P1 is embedded in and integrally fixed to the bottom surface 140au of the pin fixing portion 140a. The pin terminal P1 is disposed at the center of the bottom surface 140au of the pin fixing portion 140a, and is not in contact with the inner wall surface of the U-shaped wall portion forming the pin terminal groove portion 136a.

The pin fixing portion 140a is formed with a recessed groove (hereinafter referred to as “lead-wire groove”) 140am slightly recessed from the front side in the depth direction (arrow cd direction). The lead-wire groove 140am extends along the axis X direction and is formed to have a groove depth smaller than the groove depth of the lead-wire drawing groove portion 137a.

The pin terminal groove portions 136b to 136f also have pin fixing portions 140b to 140f in the same manner as the pin fixing portion 140a of the pin terminal groove portion 136a, and one end portion of each of the pin terminals P2 to P6 is embedded in and integrally fixed to each of bottom surfaces 140bu to 140fu of the pin fixing portions 140b to 140f. The pin fixing portions 140b to 140f also have lead-wire grooves 140bm to 140fm in the same manner as the lead-wire groove 140am of the pin fixing portion 140a.

The pin terminal groove portion 136a has two wall portions facing each other and having a U-shaped cross section forming a groove space, and has a cutout portion 141a wherein a lower end portion of the wall portion adjacent to the lead-wire drawing groove portion 137a is cut out in a rectangular shape.

It can also be said that the cutout portion 141a is formed at a lower end portion of a wall portion adjacent to the pin terminal groove portion 136a out of two wall portions facing each other and having a U-shaped cross section forming the groove space of the lead-wire drawing groove portion 137a.

The cutout portion 141a of the pin terminal groove portion 136a is formed by cutting out the lower end portion of the wall portion to such a size that the pin terminal groove portion 136a and the lead-wire drawing groove portion 137a spatially communicate with each other. However, the present invention is not limited to the configuration, and as long as the pin terminal groove portion 136a and the lead-wire drawing groove portion 137a communicate with each other, the cutout portion 141a may be formed by cutting out the central portion of the wall portion or may be formed as a through hole portion composed of a through hole instead of the cutout portion 141a. In this way, the pin terminal groove portion 136a and the lead-wire drawing groove portion 137a communicate with each other via the cutout portion 141a provided between the pin terminal groove portion 136a and the lead-wire drawing groove portion 137a.

In the left-side pin terminal groove portion 136L, the cutout portions 141a to 141c are provided in the wall portions of the pin terminal groove portions 136a to 136c adjacent to the right-side (arrow f direction) lead-wire drawing groove portions 137a to 137c when the pin terminal block 135 is viewed from the front side. That is, in the pin terminal groove portions 136a to 136c, no cutout portion is provided at the wall portion at the left side (arrow e direction) when the pin terminal block 135 is viewed from the front side.

In the right-side pin terminal groove portion 136R, the cutout portions 141d to 141f are provided in the wall portions of the pin terminal groove portions 136d to 136f adjacent to the left-side (arrow e direction) lead-wire drawing groove portions 137d to 137f when the pin terminal block 135 is viewed from the front side. That is, in the pin terminal groove portions 136d to 136f, no cutout portion is provided at the wall portion at the right side (arrow f direction) when the pin terminal block 135 is viewed from the front side.

### Effects of Coil Device

In the above-described configuration, as illustrated in FIG. 8 (A), in the bobbin 130 of the coil device 100, the pin terminals P1 to P6 are fixed to the bottom surfaces 140au to 140fu of the pin fixing portions 140a to 140f provided at the pin terminal groove portions 136a to 136f of the pin terminal block 135. Note that, the bobbin 130 in FIG. 8 (A) is illustrated in a state where the vertical direction (arrow ab direction) is turned upside down.

The bottom surfaces 140au to 140fu of the pin fixing portions 140a to 140f are located at higher positions (arrow a direction) than the bottom surface 135u of the pin terminal block 135. On the other hand, as illustrated in FIG. 8 (B), in a pin terminal block 235 of a bobbin 230 having a conventional structure, one end portion of each of pin terminals P1 and P6 is fixed in a state of being directly embedded in a bottom surface 235u of the pin terminal block 235.

Therefore, in the bobbin 130 of the coil device 100, since the pin terminals P1 to P6 are fixed to the bottom surfaces 140au to 140fu of the pin fixing portions 140a to 140f located at a higher position (arrow a direction) than the bottom surface 135u of the pin terminal block 135, the root portions of the pin terminals P1 to P6 are accommodated in the groove spaces of the pin terminal groove portions 136a to 136f and are not exposed to the outside as compared with the conventional bobbin 230.

Therefore, for example, as illustrated in FIG. 9 (A), a winding start wire 181 of the lead wires drawn out from the coil 180 (FIGS. 1 and 2) wound around the winding core portion 131 of the bobbin 130 passes through the lead-wire drawing groove portion 137c, is led out to the groove space of the pin terminal groove portion 136c via the cutout portion 141c of the pin terminal groove portion 136c, and is then soldered in a state of being tied to the root portion of the pin terminal P3.

Similarly, a winding end wire 182 of the lead wires drawn out from the coil 180 passes through the lead-wire drawing groove portion 137b, is drawn out to the pin terminal groove portion 136b via the cutout portion 141b of the pin terminal groove portion 136b, and is then soldered in a state of being tied to the root portion of the pin terminal P2.

On the other hand, as illustrated in FIG. 9 (B), in the pin terminal block 235 of the conventional bobbin 230, the winding start wire 181 of the lead wires drawn out from the coil 180 passes through a lead-wire drawing groove 237c, runs along the bottom surface 235u of the pin terminal block 235, and is soldered in a state of being tied to the root portion of the pin terminal P3.

Similarly, the winding end wire 182 of the lead wires drawn out from the coil 180 passes through a lead-wire drawing groove 237b, runs along the bottom surface 235u of the pin terminal block 235, and is soldered in a state of being tied to the root portion of the pin terminal P2.

Therefore, in the conventional bobbin 230, since the pin terminals P1 and P6 are directly fixed to the bottom surface 235u of the pin terminal block 235, solder portions 181s and 182s of the winding start wire 181 and the winding end wire 182 of the coil 180 are exposed from the bottom surface 235u.

In this case, since a short circuit occurs when the solder portion 181s of the winding start wire 181 and the solder portion 182s of the winding end wire 182 come into contact with the circuit pattern of the circuit board 300, in order to avoid the short circuit, a turned letter portion 236 for maintaining a distance between the pin terminal block 235 and the circuit board 300 is required. Therefore, in the coil device using the conventional bobbin 230, the height in the vertical direction (arrow ab direction) cannot be reduced due to the presence of the turned letter portion 236.

On the other hand, as illustrated in FIG. 9 (A), in the bobbin 130 of the coil device 100, the winding start wire 181 of the coil 180 is soldered to the root portion of the pin terminal P3 fixed to the pin fixing portion 140c of the pin terminal groove portion 136c, and the winding end wire 182 of the coil 180 is soldered to the root portion of the pin terminal P2 fixed to the pin fixing portion 140b of the pin terminal groove portion 136b.

Therefore, in the coil device 100, the solder portion 181s of the winding start wire 181 and the solder portion 182s of the winding end wire 182 in the coil 180 are disposed in the groove spaces of the pin terminal groove portions 136c and 136b, and are not exposed from the bottom surface 135u of pin terminal block 135. Therefore, in the coil device 100, the turned letter portion 236 as in the conventional bobbin 230 is not necessary, and the height in the vertical direction (arrow ab direction) can be reduced than the height in the vertical direction of the conventional bobbin 230.

In the conventional bobbin 230, as illustrated in FIG. 10 (B), a distance (interval) D1 between the solder portion 181s of the winding start wire 181 and the winding end wire 182 is short at the bottom surface 235u of the pin terminal block 235, and it is difficult to secure an insulating distance.

However, in the coil device 100, as illustrated in FIG. 10 (A), between the solder portion 181s of the winding start wire 181 and the winding end wire 182 of the coil 180, there is a wall where the cutout portion 141c of the pin terminal groove portion 136c is not provided, and thus the insulating distance (spatial distance) between the solder portion 181s and the winding end wire 182 can be increased by the amount of that wall.

That is, in the coil device 100, it is not necessary to increase the distance between the pin terminals P1 to P6, and it is also not necessary to separately provide other pin terminals, and it is possible to reduce the risk of short circuit between the winding start wire 181 and the winding end wire 182 of the coil 180 as compared with the conventional coil device.

In the coil device 100, the solder portion 181s of the winding start wire 181 and the solder portion 182s of the winding end wire 182 in the coil 180 are disposed in the groove spaces of the pin terminal groove portion 136c and the pin terminal groove portion 136b and are not exposed from the bottom surface 135u of the pin terminal block 135. Therefore, when the circuit board 300 is attached and fixed to the bottom surface 135u of the pin terminal block 135, floating, inclination, rattling, and the like of the circuit board 300 can also be eliminated.

### OTHER EMBODIMENTS

Although the coil device 100 has been described as an embodiment in the present invention, the present invention is not limited to the coil device 100.

For example, although the coil device 100 has a configuration where the single coil 180 is wound around the winding core portion 131 of the bobbin 130, the present invention may be applied to a transformer device instead of the coil device 100.

In this case, the present invention may be applied to a transformer device where a primary side coil and a secondary side coil are wound on the winding core portion 131 of the bobbin separately in the vertical direction (arrow ab direction), the winding start line and the winding end line of the primary side coil are connected to any of the pin terminals P1 to P3 of the left-side pin terminal groove portion 136L, and the winding start line and the winding end line of the secondary side coil are connected to any of the pin terminals P4 to P6 of the right-side pin terminal groove portion 136R.

Alternatively, the present invention may be applied to a transformer device where a primary side coil and a secondary side coil are wound on the winding core portion 131 of the bobbin separately in the radial direction, the winding start wire and the winding end wire of the primary side coil are connected to the pin terminals P1 to P6 of the pin terminal groove portion 136, and the winding start wire and the winding end wire of the secondary side coil are connected to the circuit board 300 by flying wires (aerial wires).

In the bobbin 130 of the coil device 100, the pin terminal block 135 is provided to the lower protruding portion 133b of the lower flange portion 133. However, the present invention is not limited to the configuration, and the pin terminal block may also be provided to the lower protruding portion 133c, and the bobbin 130 may have other various shapes.

In the coil device 100 of the present invention, for example, the winding start wire 181 of the lead-wire drawing groove portion 137c is led out to the pin terminal groove portion 136c through the cutout portion 141c. However, the present invention is not limited to the configuration, and the winding start wire 181 may be led out to the pin terminal groove portion 136c through a lead-wire groove 140cm of the pin terminal groove portion 136c instead of the lead-wire drawing groove portion 137c.

In addition, the coil device and the transformer device according to the present invention can be appropriately modified and the combinations of the various configurations can be modified, by a person skilled in the art according to previously known knowledge. Such modifications are of course included in the scope of the present invention as long as these modifications still include the configurations of the present invention.

### REFERENCE SIGNS LIST

100: Coil device, 110: Upper core, 110a: Top plate portion, 110b: Middle leg portion, 110c, 110d: Side leg portion, 120: Lower core, 120a: Bottom plate portion, 120b: Middle leg portion, 120c, 120d: Side leg portion, 130: Bobbin, 131: Winding core portion, 132: Upper flange portion (flange portion), 132a: Upper flange body, 132b, 132c: Upper protruding portion, 133: Lower flange portion (flange portion), 133a: Lower flange body, 133b, 133c: Lower protruding portion, 135: Pin terminal block, 135u: Bottom surface, 131h: Through hole, 136a to 136f: Pin terminal groove portion, 136L: Left-side pin terminal groove portion, 136R: Right-side pin terminal groove portion, 137a to 137f: Lead-wire drawing groove portion, 140a to 140f: Pin fixing portion, 140au to 140fu: Bottom surface, 140am to 140fm: Lead-wire groove, 141a to 141f: Cutout portion, 180: Coil, P (P1 to P6): Pin terminal, PLeft: Left-side pin terminal group, PRight: Right-side pin terminal group.

1. A coil device comprising:
a bobbin including a winding core portion;
a coil wound around the winding core portion;
a flange portion provided integrally with the winding core portion;
a pin terminal block provided integrally with the flange portion;
a plurality of pin terminals provided at the pin terminal block at predetermined intervals and connected to a lead wire of the coil; and
a circuit board connected to the plurality of pin terminals, wherein
the pin terminal block includes:
a plurality of pin terminal groove portions formed in a groove shape along an axial direction of the winding core portion; and
a pin fixing portion formed in an interior space of the pin terminal groove portion and integrally fixed to one end portion of the pin terminal.

2. The coil device according to claim 1, wherein
the pin terminal block includes a plurality of lead-wire drawing groove portions each formed in a groove shape along the axial direction between the plurality of pin terminal groove portions.

3. The coil device according to claim 2, wherein
the pin terminal groove portion includes two wall portions opposing each other and having a U-shaped cross section, and the wall portion adjacent to the lead-wire drawing groove portion includes a cutout portion or a through hole portion.

4. The coil device according to claim 2, wherein
the pin terminal groove portion has a groove depth deeper than a groove depth of the lead-wire drawing groove portion.

5. The coil device according to claim 1, wherein
the circuit board is fixed to a bottom surface of the pin terminal block in a state of being in contact with the bottom surface.

6. A transformer device comprising:
a bobbin including a winding core portion;
a primary side coil and a secondary side coil wound around the winding core portion;
a flange portion provided integrally with the winding core portion;
a pin terminal block provided integrally with the flange portion;
a plurality of pin terminals provided at the pin terminal block at predetermined intervals and connected to a lead wire of the primary side coil; and
a circuit board connected to the plurality of pin terminals, wherein
the pin terminal block includes:
a plurality of pin terminal groove portions formed in a groove shape along an axial direction of the winding core portion; and
a pin fixing portion formed in an interior space of the pin terminal groove portion and integrally fixed to one end portion of each of the pin terminals.
